(19) United States
(12) Patent Application Publication
(10) Pub. No.: US 2026/0078477 A1
(43) Pub. Date: Mar. 19, 2026

(54) PLATED STEEL SHEET

(71) Applicant: NIPPON STEEL CORPORATION, Tokyo (JP)

(72) Inventors: Takuya MITSUNOBU, Tokyo (JP); Takafumi YOKOYAMA, Tokyo (JP); Hiroshi TAKEBAYASHI, Tokyo (JP)

(73) Assignee: NIPPON STEEL CORPORATION, Tokyo (JP)

(21) Appl. No.: 19/109,014

(22) PCT Filed: Sep. 6, 2023
(86) PCT No.: PCT/JP2023/032483

§ 371 Date: Mar. 5, 2025

(30) Foreign Application Priority Data
Sep. 6, 2022 (JP) 2022-141608

(51) Int. Cl. C22C 38/58; B23K 26/22; B23K 35/30; B23K 103/04; B23K 103/16; B32B 15/01; C21D 6/00; C21D 8/02; C21D 9/46; C22C 18/04; C22C 38/00; C22C 38/02; C22C 38/04; C22C 38/06; C22C 38/08; C22C 38/12; C22C 38/14; C22C 38/16; C22C 38/50; C22C 38/54; C23C 2/02; C23C 2/06

(52) U.S. Cl. CPC C22C 38/58; B23K 26/22; B23K 35/3073; B32B 15/013; C21D 6/005; C21D 8/02; C21D 8/0236; C21D 8/0247; C21D 9/46; C22C 18/04; C22C 38/001; C22C 38/002; C22C 38/005; C22C 38/02; C22C 38/04; C22C 38/06; C22C 38/08; C22C 38/12; C22C 38/14; C22C 38/16; C22C 38/50; C22C 38/54; C23C 2/022; C23C 2/06; B23K 2103/04; B23K 2103/166; B32B 2250/02; B32B 2311/20; B32B 2311/30

(57) ABSTRACT

A plated steel sheet having a high LME resistance is provided. The plated steel sheet having predetermined chemical composition, having a depth with a C concentration, measured by GDS, of 0.05% or less in a depth direction of the base steel sheet starting from an interface of the base steel sheet and plating layer of 10 μm or more, having a thickness of a layer with an area ratio of a ferrite phase of 90% or more in a depth direction from the base steel sheet surface of 20 μm or more, and having a surface roughness of the interface of the base steel sheet and plating layer of an Ra of 3.0 μm or less.

### FIELD

The present invention relates to plated steel sheet. More specifically, the present invention relates to plated steel sheet having a high LME resistance.

### BACKGROUND

In recent years, the steel sheet used in automobiles, household electric appliances, building materials, and other various fields has been made increasingly higher in strength. For example, in the automotive field, to improve fuel efficiency, high strength steel sheet has been increasingly used for the purpose of lightening the weight of car bodies.

In welding of steel sheet which has been galvanized, in particular high strength steel sheet, for example, as described in PTL 1, sometimes the drop in weldability due to liquid metal embrittlement (LME) cracking becomes a problem. LME cracking is believed to occur because at the time of welding, the surface layer part of steel sheet transforms to austenite, the molten zinc invading the grain boundaries causes the steel sheet to become brittle, and further tensile stress acts on the steel sheet at the time of welding.

Further, as disclosed in NPL 1, relating to LME cracking, it is known that the grain boundaries of the ferrite phase are lower in LME sensitivity than austenite grain boundaries.

Note that, PTL 2 discloses, as steel sheet suppressed in LME cracking and improved in weldability, steel sheet at the surface layer part of which Si oxide particles with a particle size of 20 nm or more are present in a number density of 3000 to 6000/mm² and in a suitable particle size distribution.

### CITATIONS LIST

### Patent Literature

[PTL 1] WO2019/116531
[PTL 2] WO2020/218575

### NONPATENT LITERATURE

[NPL 1] “Influence of the starting microstructure of an advanced high strength steel on the characteristics of Zn-assisted liquid metal embrittlement”, D. Bhattacharya et. al., Materials Science and Engineering: A, Vol. 804, 2021

### SUMMARY

### Technical Problem

To prevent LME cracking, it is effective to keep the Zn etc. contained in the plating layer from penetrating steel sheet transformed to austenite. There is room for improvement on this point.

The present invention, in consideration of such an actual situation, has as its object the provision of plated steel sheet having a high LME resistance.

### Solution to Problem

The inventors studied in depth the solution to this problem. As a result, they discovered that by making the steel sheet contain large amounts of Si and Al, rendering the steel sheet a suitable surface state, and performing high dew point annealing, the surface layer of the steel sheet is decarburized and the ferrite (a) phase stabilizes, the surface layer of the steel sheet is covered by a ferrite phase with a low amount of dissolved C, and, as a result, LME becomes able to be suppressed in plated steel sheet using this steel sheet.

The present invention was made by engaging in further studies based on the above findings and has as its gist the following:
(1) A plated steel sheet with a tensile strength of 780 MPa or more comprising a plating layer containing Zn on one surface or two surfaces of a base steel sheet, the chemical composition of the base steel sheet comprising, by mass %, C: 0.05 to 0.40%, Si: 0.7 to 3.0%, Mn: 0.1 to 5.0%, sol. Al: 0.7 to 2.0%, P: 0.0300% or less, S: 0.0300% or less, N: 0.0100% or less, B: 0 to 0.010%, Ti: 0 to 0.150%, Nb: 0 to 0.150%, V: 0 to 0.150%, Cr: 0 to 2.00%, Ni: 0 to 2.00%, Cu: 0 to 2.00%, Mo: 0 to 1.00%, W: 0 to 1.00%, Ca: 0 to 0.100%, Mg: 0 to 0.100%, Zr: 0 to 0.100%, Hf: 0 to 0.100%, REM: 0 to 0.100% and a balance of Fe and impurities, a total value of the contents of Si and sol. Al being 1.8% or more, a depth with a C concentration, measured by GDS, of 0.05% or less in a depth direction of the plated steel sheet starting from an interface of the base steel sheet and the plating layer being 10 μm or more, a thickness of a layer with an area ratio of a ferrite phase of 90% or more in a depth direction of the plated steel sheet starting from an interface of the base steel sheet and the plating layer being 20 μm or more, and a surface roughness of the interface of the base steel sheet and the plating layer being an Ra of 3.0 μm or less, the plating layer containing, by mass %, less than 3.0% of Fe and a balance of Zn and impurities.
(2) The plated steel sheet according to the above (1), wherein the roughness of the interface of the base steel sheet and the plating layer is an Ra of 2.0 μm or less.
(3) The plated steel sheet according to the above (1), wherein the depth with a C concentration, measured by GDS, of 0.05% or less in a depth direction of the plated steel sheet starting from an interface of the base steel sheet and the plating layer is 20 μm or more,
(4) The plated steel sheet according to the above (1), wherein the thickness of a layer with an area ratio of a ferrite phase of 90% or more in a depth direction of the plated steel sheet starting from an interface of the base steel sheet and the plating layer is 30 μm or more.
(5) The plated steel sheet according to any one of the above (1) to (4), wherein the plating layer comprises, instead of part of the Zn, by mass %, Al: 0 to 30.0% and Mg: 0 to 10.0%.
(6) The plated steel sheet according to any one of the above (1) to (4), wherein the plating layer comprises, instead of part of the Zn, by mass %, Al: 10.0 to 30.0% and Mg: 4.5 to 10.0%.

### Advantageous Effects of Invention

According to the present invention, it is possible to obtain plated steel sheet having a high LME resistance.

### BRIEF DESCRIPTION OF DRAWINGS

FIG. 1 is a view showing a layer-shaped ferrite phase formed at a surface layer of plated steel sheet of the present invention.

FIG. 2 is a view for explaining evaluation of LME resistance in examples.

### DESCRIPTION OF EMBODIMENT

Below; the present invention will be explained. The present invention is not limited to the following embodiment. First, an outline of improvement of the LME resistance in the plated steel sheet of the present invention will be explained.

LME cracking occurs due to a surface layer part of a base steel sheet of plated steel sheet being heated at the time of spot welding, the steel sheet structure of the surface layer part transforming to austenite, and the molten plating penetrating the inside of the steel sheet structure along the grain boundaries of the austenite causing the crystal grain boundaries to become brittle. It is believed that LME cracking occurs since tensile stress is applied to the base steel sheet at the time of welding. The plated steel sheet of the present invention improves the LME resistance by the structure formed at the surface layer of the base steel sheet. Note that, in the Description, the “surface layer of the base steel sheet” means the range from the surface of the base steel sheet down to a depth of 100 μm.

LME cracking occurs due to a surface layer part of steel sheet at the time of spot welding being heated, the steel sheet structure of the surface layer part transforming to austenite, and the molten plating penetrating the inside of the steel sheet structure along the grain boundaries of the austenite causing the crystal grain boundaries to become brittle. It is believed that LME cracking occurs since tensile stress is applied to the steel sheet at the time of welding. The steel sheet of the present invention improves the LME resistance by the structure formed at the surface layer. Note that, in the Description, the “surface layer of the steel sheet” means the range from the surface of the steel sheet down to a depth of 100 μm.

However, even if the concentration of C at the steel sheet surface layer is low, if there is a large amount of austenite (γ) etc. with a great LME sensitivity in the structure of the surface layer, it is believed that sometimes a drop in the LME resistance is caused. Therefore, the steel sheet in the present embodiment has a thickness of a layer with an area ratio of a ferrite phase of 90% or more in the depth direction from the interface of the base steel sheet and the plating layer made 20 μm or more. Further, in the plated steel sheet of the present invention, Si, known in the past to lower the LME resistance if contained in steel sheet, is included in a large amount. This is due to the fact that as a result of studies by the inventors, contrary to findings in the past, it was discovered that the LME resistance was improved by including Si and sol. Al in large amounts.

In the present invention, strong strain is imparted to the surface layer and the steel sheet is annealed at a high dew point without increasing the surface roughness of the steel sheet. Due to this, oxygen diffuses to the inside of the steel sheet, internal oxides are formed, and formation of external oxides can be suppressed. Due to this, it is believed that, by the effect of the composite addition of Si and Al, the C concentration of the steel sheet surface layer can be lowered and further the ferrite can be stabilized.

That is, the plated steel sheet of the present invention enables improvement of the LME resistance by forming on the surface layer of the steel sheet a layer with a low C concentration and further a high area ratio of ferrite by the combined effect of the high contents of Si and sol. Al, imparting strain to the surface layer before annealing, and control of the dew point at the time of annealing.

Below; the present invention will be explained in detail.

First, the chemical composition of the base steel sheet will be explained. Below, the “%” relating to the chemical composition will mean “mass %”. Further, in the numerical ranges in the chemical composition, numerical ranges expressed using “to” will mean ranges including the numerical values described before and after “to” as lower limit values and upper limit values.

### (C: 0.05 to 0.40%)

C (carbon) is an element securing the strength of steel. To obtain the 780 MPa or more tensile strength covered by the present invention, considering the balance with weldability and, further, to keep the C concentration of the surface layer of the base steel sheet from becoming too high, the content of C is made 0.05 to 0.40%. If the content of C is too large, even with the later explained high dew point annealing, the C concentration of the surface layer will not become low and the ferrite percentage will not become high. The content of C may be 0.07% or more, 0.10% or more, or 0.12% or more. The content of C may also be 0.35% or less, 0.30% or less, or 0.25% or less.

(Si: 0.7 to 3.0%, sol. Al: 0.7 to 2.0%, Si+sol. Al≥1.8%)

Si (silicon) is an element promoting ferrite stabilization and decarburization by composite addition with Al (aluminum). To obtain such an effect of improvement of the LME resistance, Si: 0.7 to 3.0% and sol. Al: 0.7 to 2.0% are included and further the total value of the contents of Si and sol. Al is made 1.8% or more. By the contents of Si and sol. Al satisfying such numerical ranges, in the heat treatment of the process of production of the steel sheet of the present embodiment, it is possible to promote the decarburization of the steel sheet surface layer part and stabilize the ferrite of the surface layer part. “sol. Al” means the acid soluble Al not becoming an oxide such as Al₂O₃ and able to dissolve in an acid. It is found as the Al measured after excluding the undissolved residue on filter paper formed in the process of analysis of Al. The content of Si may be 0.8% or more, 0.9% or more, or 1.0% or more. The content of Si may be 2.8% or less, 2.5% or less, or 2.0% or less. The content of sol. Al may be 0.8% or more, 0.9% or more, or 1.0% or more. The content of sol. Al may also be 1.8% or less, 1.6% or less, or 1.5% or less. The total value of the contents of Si and sol. Al may be 1.9% or more or 2.0% or more.

### (Mn: 0.1 to 5.0%)

Mn (manganese) is an element effective for improving the strength of steel by obtaining hard structures. Considering the balance of the strength of steel and drop in formability by Mn segregation, the content of Mn is made 0.1 to 5.0%. The content of Mn may be 0.5% or more, 1.0% or more, or 1.5% or more. The content of Mn may also be 4.5% or less, 4.0% or less, or 3.5% or less.

### (P: 0.0300% or Less)

P (phosphorus) is an impurity generally contained in steel. With a content of P of more than 0.0300%, the weldability is liable to fall. Therefore, the content of P is made 0.0300% or less. The content of P may be 0.0200% or less, 0.0100% or less, or 0.0050% or less. It is preferable that P not be included, so the lower limit of the content of P is 0%. From the viewpoint of dephosphorization costs, the content of P may be more than 0%, 0.0001% or more, or 0.0005% or more.

### (S: 0.0300% or Less)

S (sulfur) is an impurity generally contained in steel. With a content of S of more than 0.0300%, the weldability falls. Further, the amount of precipitation of MnS increases and the bendability and other formability is liable to fall. Therefore, the content of S is made 0.0300% or less. The content of S may also be 0.0100% or less, 0.0050% or less, 0.0030% or less, 0.0020% or less, or 0.0010% or less. It is preferable that S not be included, so the lower limit of the content of S is 0%. From the viewpoint of the desulfurization costs, the content of S may also be more than 0%, 0.0001% or more, or 0.0005% or more.

### (N: 0.0100% or Less)

N (nitrogen) is an impurity generally contained in steel. With a content of N of more than 0.0100%, the weldability is liable to fall. Therefore, the content of N is made 0.0100% or less. The content of N may also be 0.0080% or less, 0.0050% or less, 0.0030% or less, 0.0020% or less, or 0.0010% or less. It is preferable that N not be included, so the lower limit of the content of N is 0%. From the viewpoint of the production costs, the content of N may also be more than 0%, 0.0001% or more, 0.0002% or more, 0.0003% or more, or 0.0005% or more.

### (B: 0 to 0.010%)

B (boron) is an element raising the hardenability and contributing to improvement of the strength and, further, segregating at the grain boundaries to strengthen the grain boundaries and improve the toughness, so may be included in accordance with need. It is not an essential element, so the lower limit of the content of B is 0%. This effect is also obtained by inclusion in a trace amount, but the content of B when included is preferably 0.0001% or more. The content of B may also be 0.0002% or more, 0.0003% or more, 0.0005% or more, 0.0007% or more, or 0.0010% or more. On the other hand, from the viewpoint of securing sufficient toughness, the content of B is made 0.010% or less. The content of B may also be 0.0080% or less, 0.0060% or less, 0.0050% or less, 0.0040% or less, or 0.0030% or less.

### (Ti: 0 to 0.150%)

Ti (titanium) is an element precipitating as TiC during cooling of the steel and contributing to improvement of the strength, so may be included in accordance with need. It is not an essential element, so the lower limit of the content of Ti is 0%. This effect is also obtained by inclusion in a trace amount, but the content of Ti when included is preferably 0.0001% or more. The content of Ti may be 0.0002% or more, 0.0003% or more, 0.0005% or more, 0.0007% or more, or 0.0010% or more. On the other hand, if excessively included, coarse TiN is formed and the toughness is liable to be impaired, so the content of Ti is made 0.150% or less. The content of Ti may also be 0.1000% or less, 0.0500% or less, 0.0300% or less, 0.0200% or less, 0.0100% or less, 0.0050% or less, or 0.0030% or less.

### (Nb: 0 to 0.150%)

Nb (niobium) is an element contributing to improvement of strength through improvement of the hardenability, so may be included in accordance with need. It is not an essential element, so the lower limit of the content of Nb is 0%. This effect is also obtained by inclusion in a trace amount, but the content of Nb when included is preferably 0.001% or more. The content of Nb may be 0.002% or more, 0.003% or more, 0.005% or more, or 0.008% or more. On the other hand, from the viewpoint of securing sufficient toughness, the content of Nb is made 0.150% or less. The content of Nb may also be 0.100% or less, 0.060% or less, 0.050% or less, 0.040% or less, or 0.030% or less.

### (V: 0 to 0.150%)

V (vanadium) is an element contributing to improvement of strength through improvement of hardenability, so may be included in accordance with need. It is not an essential element, so the lower limit of the content of V is 0%. This effect is also obtained by inclusion in a trace amount, but the content of V when included is preferably 0.001% or more. The content of V may be 0.002% or more, 0.003% or more, or 0.005% or more. On the other hand, from the viewpoint of securing sufficient toughness, the content of V is made 0.150% or less. The content of V may also be 0.100% or less, 0.060% or less, 0.050% or less, 0.040% or less, 0.030% or less, or 0.020% or less.

### (Cr: 0 to 2.00%)

Cr (chromium) is an element effective for raising the hardenability of steel to raise the strength of steel, so may be included in accordance with need. It is not an essential element, so the lower limit of the content of Cr is 0%. This effect is also obtained by inclusion in a trace amount, but the content of Cr when included is preferably made 0.001% or more. The content of Cr may be 0.01% or more, 0.02% or more, 0.03% or more, 0.05% or more, or 0.08% or more. On the other hand, if excessively included, Cr carbides are formed in large amounts and conversely the hardenability is liable to be impaired, so the content of Cr is made 2.00% or less. The content of Cr may be 1.80% or less, 1.50% or less, 1.20% or less, 1.00% or less, 0.70% or less, 0.50% or less, or 0.30% or less.

### (Ni: 0 to 2.00%)

Ni (nickel) is an element effective for raising the hardenability of steel to raise the strength of steel, so may be included in accordance with need. It is not an essential element, so the lower limit of the content of Ni is 0%. This effect is also obtained by inclusion in a trace amount, but the content of Ni when included is preferably 0.001% or more. The content of Ni may be 0.01% or more or 0.02% or more. On the other hand, excessive addition of Ni causes the cost to rise, so the content of Ni is made 2.00% or less. The content of Ni may be 1.80% or less, 1.50% or less, 1.20% or less, 1.00% or less, 0.80% or less, 0.50% or less, 0.30% or less, 0.20% or less, 0.10% or less, or 0.05% or less.

### (Cu: 0 to 2.00%)

Cu (copper) is an element effective for raising the hardenability of steel to raise the strength of steel, so may be included in accordance with need. It is not an essential element, so the lower limit of the content of Cu is 0%. This effect is also obtained by inclusion in a trace amount, but the content of Cu when included is preferably 0.0001% or more. The content of Cu may be 0.0002% or more, 0.0003% or more, or 0.0005% or more. On the other hand, from the viewpoint of suppressing a drop in toughness or cracking of the slab after casting, the content of Cu is made 2.00% or less. The content of Cu may also be 1.8000% or less, 1.5000% or less, 1.2000% or less, 1.0000% or less, 0.5000% or less, 0.1000% or less, 0.0500% or less, 0.0100% or less, 0.0050% or less, 0.0030% or less, or 0.0020% or less.

### (Mo: 0 to 1.00%)

Mo (molybdenum) is an element effective for raising the hardenability of steel to raise the strength of steel, so may be included in accordance with need. It is not an essential element, so the lower limit of the content of Mo is 0%. This effect is also obtained by inclusion in a trace amount, but the content of Mo when included is preferably 0.001% or more. The content of Mo may be 0.01% or more, 0.02% or more, 0.03% or more, 0.05% or more, or 0.08% or more. On the other hand, from the viewpoint of suppressing a drop in toughness, the content of Mo is made 1.00% or less. The content of Mo may also be 0.90% or less, 0.70% or less, 0.50% or less, or 0.30% or less.

### (W: 0 to 1.00%)

W (tungsten) is an element effective for raising the hardenability of steel to raise the strength of steel, so may be included in accordance with need. It is not an essential element, so the lower limit of the content of W is 0%. This effect is also obtained by inclusion in a trace amount, but the content of W when included is preferably 0.001% or more. The content of W may be 0.002% or more, 0.005% or more, or 0.01% or more. On the other hand, from the viewpoint of suppressing a drop in toughness, the content of W is made 1.00% or less. The content of W may also be 0.90% or less, 0.70% or less, 0.50% or less, 0.30% or less, 0.10% or less, 0.05% or less, or 0.03% or less.

### (Ca: 0 to 0.100%)

Ca (calcium) is an element contributing to control of inclusions, in particular fine dispersion of inclusions, and having the action of raising the toughness, so may be included in accordance with need. It is not an essential element, so the lower limit of the content of Ca is 0%. This effect is also obtained by inclusion in a trace amount, but the content of Ca when included is preferably 0.0001% or more. The content of Ca may be 0.0002% or more. On the other hand, if excessively included, deterioration of the surface properties sometimes appears, so the content of Ca is made 0.100% or less. The content of Ca may also be 0.0800% or less, 0.0500% or less, 0.0100% or less, 0.0050% or less, 0.0030% or less, 0.0020% or less, 0.0010% or less, 0.0008% or less, or 0.0005% or less.

### (Mg: 0 to 0.100%)

Mg (magnesium) is an element contributing to control of inclusions, in particular fine dispersion of inclusions, and having the action of raising the toughness, so may be included in accordance with need. It is not an essential element, so the lower limit of the content of Mg is 0%. This effect is also obtained by inclusion in a trace amount, but the content of Mg when included is preferably 0.0001% or more. The content of Mg may be 0.0002% or more, 0.0003% or more, 0.0005% or more, or 0.0008% or more. On the other hand, if excessively included, deterioration of the surface properties sometimes appears, so the content of Mg is made 0.100% or less. The content of Mg may be 0.090% or less, 0.080% or less, 0.050% or less, 0.010% or less, 0.005% or less, or 0.003% or less.

### (Zr: 0 to 0.100%)

Zr (zirconium) is an element contributing to control of inclusions, in particular fine dispersion of inclusions, and having the action of raising the toughness, so may be included in accordance with need. It is not an essential element, so the lower limit of the content of Zr is 0%. This effect is also obtained by inclusion in a trace amount, but the content of Zr when included is preferably 0.001% or more. The content of Zr may be 0.002% or more, 0.003% or more, 0.005% or more, or 0.010% or more. On the other hand, if excessively included, deterioration of the surface properties sometimes appears, so the content of Zr is made 0.100% or less. The content of Zr may be 0.080% or less, 0.050% or less, 0.040% or less, or 0.030% or less.

### (Hf: 0 to 0.100%)

Hf (hafnium) is an element contributing to control of inclusions, in particular fine dispersion of inclusions, and having the action of raising the toughness, so may be included in accordance with need. It is not an essential element, so the lower limit of the content of Hf is 0%. This effect is also obtained by inclusion in a trace amount, but the content of Hf when included is preferably 0.0001% or more. The content of Hf may be 0.0002% or more, 0.0003% or more, 0.0005% or more, or 0.0008% or more. On the other hand, if excessively included, deterioration of the surface properties sometimes appears, so the content of Hf is made 0.100% or less. The content of Hf may also be 0.050% or less, 0.030% or less, 0.010% or less, 0.005% or less, or 0.003% or less.

### (REM: 0 to 0.100%)

An REM (rare earth element) is an element contributing to control of inclusions, in particular fine dispersion of inclusions, and having the action of raising the toughness, so may be included in accordance with need. It is not an essential element, so the lower limit of the content of an REM is 0%. This effect is also obtained by inclusion in a trace amount, but the content of an REM when included is preferably 0.0001% or more. The content of an REM may be 0.0003% or more or 0.0005% or more. On the other hand, if excessively included, deterioration of the surface properties sometimes appears, so the content of an REM is made 0.100% or less. The content of an REM may be 0.0500% or less, 0.0300% or less, 0.0100% or less, 0.0050% or less, 0.0030% or less, or 0.0020% or less. Note that, “REM” is an abbreviation for “rare earth metal” and means elements belonging to the lanthanoids. An REM is usually added as a mischmetal.

In the plated steel sheet according to the present invention, the balance besides the above chemical composition is comprised of Fe and impurities. Here, “impurities” are constituents which enter due to various factors in the production process, first and foremost the raw materials such as ore and scrap, when industrially producing steel sheet and which do not have a detrimental effect on the LME resistance of the plated steel sheet according to the present invention. That is, it means something included in a range in which the LME resistance of the steel sheet sought from the present invention are obtained.

The chemical composition of the base steel sheet may be analyzed using any element analysis method known to a person skilled in the art, for example, inductively coupled plasma-mass spectrometry (ICP-MS). However, C and S may be measured using the combustion-infrared absorption method, and N may be measured using the inert gas melting-thermal conductivity method. These analyses may be performed by samples taken from the base steel sheet by the method based on JIS G0417: 1999.

Next, the surface layer part of the base steel sheet will be explained.

### [C Concentration]

In the plated steel sheet of the present invention, the depth with a C concentration, measured by GDS (glow discharge spectrometry), of 0.05% or less in a depth direction of the base steel sheet is 10 μm or more. There, the starting point in the depth direction is the interface of the plating layer and the base steel sheet.

The sensitivity to LME falls the lower the C concentration, so by the C concentration at the surface layer being low, the LME resistance is improved. Further, C is an austenite stabilizing element, so by this being low in concentration, the later explained low LME sensitivity ferrite phase stabilizes.

Such a surface structure can be obtained by making the chemical composition of the steel sheet constituents in which, as explained before, Si and Al are included in large amounts and by the later explained heat treatment.

If the depth with a C concentration of 0.05% or less is 10 μm or more, the effect of improvement of the LME resistance is obtained, so the upper limit of the depth is not particularly prescribed. For example, it may be 50 μm or less, 40 μm or less, or 30 μm or less. The depth with a C concentration of 0.05% or less is preferably 20 μm or more.

The GDS measurement is performed five times in the sheet thickness direction. The average value of the measurements is made the C concentration. The measurement conditions are as explained below: The starting point of the “depth” is the interface of the base steel sheet and the plating layer. The interface of the base steel sheet and plating layer is made the position where the concentration of Fe measured by GDS measurement becomes 93% of the concentration of Fe at the depth of 150 ∪m.

Apparatus: high frequency glow discharge optical emission spectrometry (made by LECO Japan, model “GDS850A”)
Ar gas pressure: 0.3 MPa
Anode diameter: 4 mmφ
RF output: 30W
Measurement time: 200 to 1500 seconds

### [Ferrite Phase]

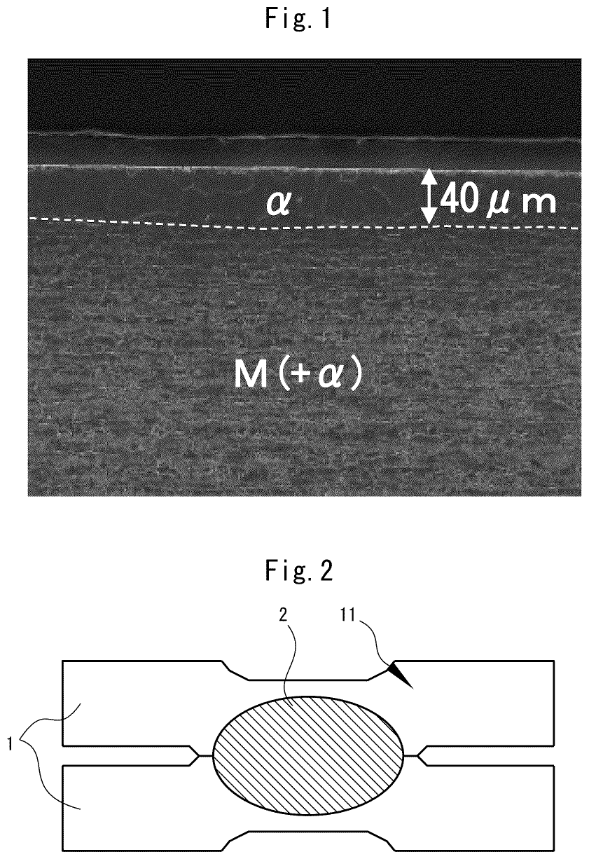

In the plated steel sheet of the present invention, the thickness of the layer with an area ratio of a ferrite phase of 90% or more in the depth direction from the base steel sheet surface is 20 μm or more. Here, the starting point in the depth direction is the interface of the plating layer and the base steel sheet. FIG. 1 shows one example of a photograph of the structure obtained by an SEM near the surface layer of the plated steel sheet of the present invention. FIG. 1 shows a cross-section of the plated steel sheet in the thickness direction. The upper side in the drawing is the plated steel sheet surface. The steel sheet surface layer in FIG. 1 includes a layer with a low C concentration and with an area ratio of a ferrite (α) phase of 90% or more. The inside of the base steel sheet is comprised of a structure mainly consisting of martensite (M) and containing ferrite. In the plated steel sheet of FIG. 1, the layer with an area ratio of ferrite of 90% or more is present at the surface layer of the base steel sheet at a thickness of 40 μm.

It is known that grain boundaries of a ferrite phase are lower in LME sensitivity than γ (austenite) grain boundaries (for example, NPL 1). Therefore, due to the fact that a structure mainly comprised of the ferrite phase is thickly present at the surface layer part of the base steel sheet, even if the plating melts, LME becomes difficult to occur and the LME resistance can be improved. Such a surface layer structure can be obtained by making the chemical composition of the base steel sheet, as explained above, constituents in which Si and Al are included in large amounts and by the later explained heat treatment.

If the thickness of the region with an area ratio of a ferrite phase of 90% or more becomes 20 μm or more, the effect of improvement of the LME resistance is obtained, so the upper limit of the thickness is not particularly prescribed. For example, the thickness may be made 100 μm or less, 80 μm or less, or 60 μm or less. The thickness of the region with an area ratio of a ferrite phase of 90% or more is preferably 30 μm or more.

The thickness of the region with an area ratio of a ferrite phase of 90% or more is determined by etching an L-cross-section of the base steel sheet by Nital and examining it by an SEM. From the form of that structure, martensite, bainite, and ferrite can be differentiated. Specifically, the L-direction cross-section is polished. After polishing it to a mirror finish, Nital etching is used to corrode and bring out the steel structure. After that, secondary electron images of five fields are captured by a magnification of 1500×at equal intervals in a range of 500 μm from the steel surface down in the depth direction. The area ratios of the ferrite phases were measured by the point counting method (based on ASTM E562) and the thickness of the region with an area ratio of a ferrite phase of 90% or more was measured for each captured field.

Here, the “area ratio of the ferrite phase” means the area ratio found by observation at the L-cross-section. Even if there is locally a location in the middle of the thickness direction where the area ratio of a ferrite phase becomes less than 90% when locally observing the C-cross-section, there is no problem so long as the area ratio of a ferrite phase of the L-cross-section at the depth down to 20 μm is 90% or more. The more specific area ratio is as explained below:

The ferrite area ratio is measured as follows: A cross-section of the base steel sheet in the sheet thickness direction orthogonal to the rolling direction is cut out, is polished to a mirror finish, then is corroded by a Nital solution to bring out the steel structure. A field emission scanning electron microscope is used to capture a secondary electron image. The range of the field observed is made a range from the interface of the base steel sheet and plating layer to 500 μm down in the depth direction. Five fields were observed at equal intervals. In the obtained structural photographs, the point counting method is used to calculate the percentages of the different structures. First, an evenly spaced grid is drawn on the structural photograph. Next, it is judged which of tempered martensite, pearlite, ferrite, fresh martensite, or retained austenite or bainite the structures at the grid points correspond to. The numbers of grid points corresponding to the different structures can be found and divided by the total number of grid points to measure the percentages of the different structures. In the present invention, the grid spacings are made 2 μm×2 μm and the total number of grid points is made 1500 points.

The criteria for judgment of pearlite, ferrite, martensite, and bainite are as follows: A region having substructures (lath boundaries and block boundaries) in the grains and having carbides precipitating in several variants is judged as tempered martensite. Further, a region in which cementite precipitates in a lamellar form is judged as pearlite. A region in which the brightness is low and no substructures can be observed is judged as ferrite. A region in which the brightness is high and substructures are not brought out by etching is judged as fresh martensite or retained austenite. A region not corresponding to any of the above is judged as bainite. Simply put, if differentiating ferrite and other structures, the area ratio of the ferrite phase can be found.

The plated steel sheet according to the present invention is comprised of the base steel sheet explained above having a plating layer on its surface. This plating layer may be formed on one surface of the steel sheet or may be formed on both surfaces.

### [Chemical Composition of Plating Layer]

The chemical composition of the hot dip galvannealed layer in the present invention will be explained next. The “%” relating to the contents of the elements, unless particularly indicated otherwise, will mean “mass %”. In the numerical ranges in the chemical composition of the plating layer, unless particularly indicated otherwise, numerical ranges expressed using “to” will mean ranges including the numerical values described before and after “to” as lower limit values and upper limit values.

### (Fe: 3.0% or Less)

Fe is not included in the plating bath but can be contained in the plating layer by diffusion from the base steel sheet when forming a plating layer containing Zn on the base steel sheet then heat treating the plated steel sheet. Therefore, since Fe is not contained in the plating layer in the state where no heat treatment is performed, the content of Fe may be 0%. Further, the content of Fe may be 3.0% or less. For example, it may also be 2.0% or less or 1.0% or less.

In the plating layer, the balance other than the above constituents is comprised of Zn and impurities. The impurities in the plating layer mean constituents which enter due to various factors in the production process, first and foremost the raw materials, when producing the plating layer and not constituents intentionally added to the plating layer. In the plating layer, elements other than the basic constituents and optionally added constituents explained above may be included as impurities in trace amounts in a range not obstructing the effect of the present invention.

The plating layer may also contain Al: 0 to 30.0% and Mg: 0 to 10.0% in place of part of the Zn.

### (Al: 0 to 30.0%)

Al is an element included together with Zn and improving the corrosion resistance of the plating layer, so may be included in accordance with need. Therefore, the content of Al may be 0%. For forming a plating layer containing Zn and Al, preferably the content of Al may be 0.01% or more. For example, it may be 1.0% or more, 3.0% or more, 5.0% or more, 10.0% or more, or 15.0% or more. If the content of Al becomes too large, the effect of improvement of the corrosion resistance becomes saturated, so the content of Al may be 30.0% or less, for example may be 25.0% or less and 20.0% or less.

### (Mg: 0 to 10.0%)

Mg is an element included together with Zn and Al and improving the corrosion resistance of the plating layer, so may be included in accordance with need. Therefore, the content of Mg may be 0%. For forming a plating layer containing Zn, Al, and Mg, preferably the content of Mg may be 0.01% or more. For example, it may be 1.0% or more, 2.0% or more, 3.0% or more, 4.5% or more, or 5.0% or more. If the content of Mg is too large, poor appearance and nonplating defect sometimes occur, so the content of Mg may be 10.0% or less, for example may be 8.0% or less and 6.0% or less.

The chemical composition in the plating layer can be determined by dissolving the plating layer in an acid solution containing an inhibitor for suppressing corrosion of the base steel sheet and measuring the obtained solution by ICP (high frequency inductively coupled plasma) emission spectroscopy. The acid solution containing the inhibitor may, for example, be a 10 mass % hydrochloric acid solution containing 0.06 mass % of an inhibitor (Ibit made by Asahi Chemicals Co., Ltd.)

The thickness of the plating layer may be, for example, 3 to 50 μm. Further, the amount of deposition of the plating layer is not particularly limited, but, for example, may be 10 to 170 g/m² per surface. In the present invention, the amount of deposition of the plating layer is determined by dissolving the plating layer in an acid solution containing an inhibitor for suppressing corrosion of the base steel sheet and measuring the change in weight before and after removal of the plating layer by the acid wash. The thickness of the plating layer may be 5 μm or more, 10 μm or more, 15 μm or more, or 20 μm or more. The thickness of the plating layer may also be 40 μm or less or 30 μm or less. The amount of deposition of the plating layer may be, per surface, 20 g/m² or more, 30 g/m² or more, 40 g/m² or more, or 50 g/m² or more. The amount of deposition of the plating layer may also be, per surface, 150 g/m² or less, 130 g/m² or less, 120 g/m² or less, or 100 g/m² or less.

### [Surface Roughness]

The steel sheet of the present invention has a surface roughness of the interface of the plating layer and base steel sheet of the arithmetic average roughness Ra defined by JIS B0601: 2013 of 3.0 μm or less. If the roughness becomes greater, stress concentration causes cracking to more easily occur, so the LME resistance falls. The roughness of the interface may also be made the surface roughness of the base steel sheet measured by removing the plating. Considering the adhesion of the plating, Ra may be 2.5 μm or less or 2.0 μm or less.

### [Tensile Strength]

The present invention suppresses the LME which occurs in high strength steel sheet, so the steel sheet according to the present invention is high in strength. Specifically, it has a 780 MPa or more tensile strength. The upper limit of the tensile strength is not particularly prescribed, but from the viewpoint of securing toughness, for example, it may be 2000 MPa or less. The tensile strength may be measured by taking a JIS No. 5 tensile test piece having a direction at right angles to the rolling direction as its longitudinal direction and subjecting it to JIS Z 2241:2011. The tensile strength may be 880 MPa or more, 980 MPa or more, 1080 MPa or more, or 1180 MPa or more. The tensile strength may also be 1900 MPa or less or 1800 MPa or less.

The sheet thickness of the plated steel sheet of the present invention is not particularly limited. For example, it may be made 0.6 to 3.2 mm. The sheet thickness may be 0.8 mm or more or 1.0 mm or more. The sheet thickness may be 3.0 mm or less, 2.6 mm or less, 2.4 mm or less, 2.2 mm or less, 2.0 mm or less, or 1.8 mm or less.

Next, the method of production of the plated steel sheet according to the present invention will be explained.

The plated steel sheet according to the present invention can, for example, be obtained by a method of production provided with a casting step of casting molten steel adjusted in chemical composition to form a steel slab, a hot rolling step of hot rolling the steel slab to obtain hot rolled steel sheet, a coiling step of coiling the hot rolled steel sheet, a cold rolling step of cold rolling the coiled hot rolled steel sheet to obtain a cold rolled steel sheet, a pretreatment step of brushing the cold rolled steel sheet, an annealing step of annealing the treated cold rolled steel sheet, and a plating step of plating the annealed cold rolled steel sheet. Alternatively, it is also possible to not perform coiling after the hot rolling step but to perform pickling then cold rolling in that state.

### [Casting Step]

The conditions of the casting step are not particularly limited. For example, it is sufficient to cast the steel by melting it in a blast furnace or electric arc furnace etc., then performing various secondary refining processes, then performing the usual continuous casting, casting by the ingot method, etc. or other method.

### [Hot Rolling Step]

The steel slab obtained by the casting can be hot rolled to obtain hot rolled steel sheet. The hot rolling step is performed by hot rolling the cast steel slab directly or after reheating after cooling it once. If reheating, the heating temperature of the steel slab may be, for example, 1100 to 1250° C. In the hot rolling step, usually rough rolling and finish rolling are performed. The temperatures and reduction rates of the rolling processes may be suitably changed in accordance with the desired microstructure and sheet thickness. For example, the end temperature of the finish rolling may be 900 to 1050° C. and the rolling reduction of the finish rolling may be 10 to 50%.

### [Coiling Step]

The hot rolled steel sheet can be coiled at a predetermined temperature. The coiling temperature may be suitably changed in accordance with the desired microstructure etc. For example, it may be 500 to 800° C. Predetermined heat treatment may be applied to the hot rolled steel sheet before coiling or after coiling. Alternatively, the steel sheet need not be coiled, but can be pickled then cold rolled as explained later after the hot rolling step.

### [Cold Rolling Step]

After the hot rolled steel sheet is pickled etc., the hot rolled steel sheet can be cold rolled to obtain cold rolled steel sheet. The reduction rate in the cold rolling may be suitably changed in accordance with the desired microstructure and sheet thickness. For example, it may be 20 to 80%. After the cold rolling step, for example, the steel sheet may be air cooled to cool it down to room temperature.

### [Pretreatment Step]

As explained above, at the surface layer of the steel sheet, the thickness of the layer with an area ratio of a ferrite phase of 90% or more in the depth direction is made 20 μm or more. To make the depth with a C concentration of 0.05% or less in the depth direction 10 μm or more by GDS measurement, it is necessary to perform predetermined pretreatment then annealing.

The pretreatment includes using a brush roll to grind down the cold rolled steel sheet surface (brushing treatment). As the brush roll which can be used, for example, M-33 made by Hotani Co., Ltd. may be mentioned. Due to this, strain can be introduced without making the roughness of the surface greater. At the time of grinding, the steel sheet surface may be coated with an NaOH 1.0 to 5.0% aqueous solution. The brushing reduction may be made 0.5 to 10.0 mm and the speed 100 to 1000 rpm. By controlling the coating solution conditions, brushing reduction, and speed in performing the brushing treatment, decarburization is promoted in the annealing step explained below and a stable ferrite structure can be efficiently formed at the surface layer of the steel sheet.

### [Annealing Step]

After the pretreatment step, the cold rolled steel sheet is annealed. The annealing is, for example, performed in a state applying 1 to 20 MPa tension. If applying tension at the time of annealing, it becomes possible more effectively introduce strain to the steel sheet and decarburization of the surface layer is promoted.

The holding temperature of the annealing step is made 750 to 900° C. The holding temperature may also be 770 to 870° C. By making it such a range, it is possible to promote decarburization, reduce the C concentration of the surface layer, and stabilize the ferrite phase. The rate of temperature rise up to the holding temperature is not particularly limited, but may be 1 to 10° C./s.

The holding time at the holding temperature of the annealing step is made 20 to 300 seconds. The holding time may be between 30 to 250 seconds. By making it such a range, it is possible to promote decarburization, reduce the C concentration of the surface layer, and stabilize the ferrite phase.

The atmosphere of the annealing step is made the dew point −30 to 20° C. The dew point may also be −10 to 5° C. The atmosphere, for example, may also be N₂-1 to 10 vol % H₂, N₂-2 to 4 vol % H₂. If the dew point is too high or too low, a phase containing Si, Mn, Al, and other oxides is formed at the outside of the steel sheet and decarburization is no longer promoted. Furthermore, sometimes mutual diffusion of the plating constituents and steel constituents is obstructed and the plateability becomes insufficient.

Due to the method of production provided with the above-mentioned steps, in the surface layer of the steel sheet, decarburization is promoted and steel sheet with a stabilized ferrite phase can be obtained.

### [Plating Step]

Next, after the annealing, the cold rolled steel sheet is plated. The plating may be performed by a method known to persons skilled in the art. The plating may for example be performed by hot dip coating or may be performed by electroplating. Preferably, the plating is performed by hot dip coating. The conditions of the plating may be suitably set considering the desired chemical composition, thickness, amount of deposition, etc. of the plating layer. For example, it may be performed by dipping in a 420 to 480° C. hot dip galvanization bath adjusted in chemical composition for 1 to 10 seconds, pulling out the sheet after dipping at 20 to 200 mm/s, and wiping by N₂ gas to control the amount of plating deposition.

The plated steel sheet according to the present invention is high in strength and has a high LME resistance, so can be suitably used in automobiles, household electrical appliances, building materials, and other broad fields. In particular, it is preferably used in the automotive field. The plated steel sheet used for automobiles is often spot welded. In that case, LME cracking can become a remarkable problem. For this reason, when using the plated steel sheet according to the present invention as steel sheet for automotive use, the effect of the present invention of imparting a high LME resistance is optimally taken advantage of.

Further, the plated steel sheet of the present invention is formed with a thick decarburized layer at its surface layer, so is also excellent in corrosion resistance and is optimal for the automotive field in this regard as well.

### EXAMPLES

Below, examples will be used to explain the present invention in more detail. The present invention is not limited to these examples.

### Examples A

First, the experiments which the inventors performed preliminarily for obtaining the present invention will be explained. The inventors spot welded steel sheets changed in contents of Si and Al (sheet thicknesses 1.2 mm) and general hot dip galvannealed steel sheet (sheet thickness 1.6 mm) under the conditions shown in Table 1 and checked for LME internal cracking at the time of spot welding. The results are shown in Table 2. As shown in Table 2, it was confirmed that LME is suppressed in high Si-high Al steel.

TABLE 1

| | Disturbance | | Weld conditions | | | | |
|---|---|---|---|---|---|---|---|
| | Electrode | | | | Energizing | Holding | Energizing |
| Electrodes | angle | Clearance | Load | Squeeze | time | time | current |
| 6φ40R(Cu-Cr) | 3° | 0.3 mm | 400 kgf | 0.6 s | 0.36 s | 0.08 s | 8 kA |

TABLE 2

| | Chemical composition (mass %) | | | | | | Crack length |
|---|---|---|---|---|---|---|---|
| No. | C | Si | Mn | P | S | Al | (mm) |
| 1 | 0.2 | 0.51 | 2.46 | 0.011 | 0.0011 | 0.49 | 0.6 |
| 2 | 0.2 | 0.51 | 2.48 | 0.011 | 0.0011 | 0.98 | 0.2 |
| 3 | 0.2 | 0.51 | 2.48 | 0.011 | 0.0010 | 1.53 | 0.7 |
| 4 | 0.2 | 0.97 | 2.45 | 0.010 | 0.0011 | 0.48 | 0.3 |
| 5 | 0.2 | 0.97 | 2.45 | 0.010 | 0.0010 | 0.96 | 0.0 |
| 6 | 0.2 | 1.00 | 2.44 | 0.010 | 0.0011 | 1.32 | 0.0 |

### Examples B

### (Preparation of Steel Sheet Samples)

### Example 1

Molten steel adjusted to the chemical composition described in No. 1 of Table 3 was smelted in a blast furnace and cast by continuous casting to obtain a steel slab. The obtained steel slab was heated to 1200° C. and hot rolled by an end temperature of finish rolling of 950° C. and a rolling reduction of the finish rolling of 30% to obtain hot rolled steel sheet. The obtained hot rolled steel sheet was coiled at the coiling temperature of 650° C., was pickled, then was cold rolled by a reduction rate of 50% to obtain cold rolled steel sheet. The sheet thickness of the cold rolled steel sheet was 1.6 mm.

Next, the cold rolled steel sheet was coated with an NaOH 2.0% aqueous solution and brushed as pretreatment. The brushing was performed using as a brushing roll the M-33 made by Hotani Co., Ltd. at a brushing reduction of 2.0 mm and speed of 600 rpm (Condition A of Table 4).

After the pretreatment step and before the annealing step, the surface roughness of the steel sheet was measured based on JIS B 0601:2013. That is, 10 locations at the surface of the surface layer part side were randomly selected and the respective locations were measured for surface profiles by a contact type surface roughness meter. The surface roughnesses at these locations were averaged. The arithmetic average roughness Ra was evaluated as follows:
Evaluation AA: 2.0 μm or less
Evaluation A: more than 2.0 μm and 3.0 μm or less
Evaluation B: more than 3.0 μm

After that, the steel sheet was annealed at a dew point of 0° C., a holding temperature of 800° C., and a holding time of 100 seconds inside a furnace with an oxygen concentration of 20 ppm or less in an N₂-4% H₂ gas atmosphere to prepare a steel sheet sample. In all of the steel sheet samples, the rate of temperature rise at the time of annealing was made 6.0° C./s up to 500° C. and 2.0° C./s from 500° C. to the holding temperature. The annealing treatment was performed in a state applying 15 MPa tension.

After the annealing, plating was performed to obtain plated steel sheet. The plating was performed by dipping in a 460° C. hot dip galvanization bath (Zn-0.2% Al) for 3 seconds, pulling it out after dipping by 100 mm/s, and wiping by N₂ gas to control the amount of plating deposition to 50 g/m².

### Examples 2 to 28 and Comparative Examples 29 to 41

Except for making the chemical composition those described in Table 3 and making the conditions of the pretreatment steps, the annealing steps, and the plating steps those described in Table 4, the same procedure was followed as in Example 1 to produce plated steel sheets. Note that, in No. 40, pretreatment by brush grinding was omitted. Further, in No. 41, a D-100 made by Hotani Co., Ltd. was used as the brushing roll (Condition B of Table 4). D-100 is a roll with a grinding amount 2 times greater than M-33. The compositions of the plating types shown in Table 4 and the bath temperatures are as follows:
A: Zn-0.2% Al (460° C.)
B: Zn-0.5% Al (440° C.)
C: Zn-1.5% Al-1.5% Mg (500° C.)
D: Zn-20% Al-7% Mg (530° C.)
E: Zn-30% Al-10% Mg (530° C.)

TABLE 3

| | | Chemical composition (mass %), bal.: Fe and impurities | | | | | | | | | | |
|---|---|---|---|---|---|---|---|---|---|---|---|---|
| No. | Class | C | Si | Mn | sol. Al | P | S | N | B | Ti | Others | Si + sol. Al |
| 1 | Ex. | 0.05 | 0.9 | 2.0 | 0.9 | 0.0001 | 0.0003 | 0.0002 | | | | 1.8 |
| 2 | Ex | 0.10 | 0.9 | 2.0 | 1.0 | 0.0080 | 0.0005 | 0.0004 | 0.0009 | 0.0005 | | 1.9 |
| 3 | Ex | 0.10 | 1.0 | 2.0 | 1. | 0.0080 | 0.0007 | 0.0005 | 0.0007 | 0.0006 | Hf: 0.001 | 2.1 |
| 4 | Ex. | 0.10 | 1.2 | 2.0 | 1.0 | 0.0070 | 0.0002 | 0.0008 | 0.0002 | 0.0005 | | 2.2 |
| 5 | Ex. | 0.10 | 0.9 | 2.2 | 1.0 | 0.0020 | 0.0009 | 0.0009 | 0.0009 | 0.0002 | Mg: 0.001 | 1.9 |
| 6 | Ex. | 0.20 | 1.0 | 2.0 | 1.0 | 0.0100 | 0.0004 | 0.0004 | 0.0007 | 0.0002 | | 2.0 |
| 7 | Ex. | 0.20 | 0.9 | 2.0 | 1.0 | 0.0020 | 0.0006 | 0.0007 | 0.0008 | 0.0003 | Zr: 0.015 | 1.9 |
| 8 | Ex. | 0.20 | 1.0 | 2.2 | 0.8 | 0.0008 | 0.0009 | 0.0007 | 0.0009 | 0.0005 | Cr: 0.1 | 1.8 |
| 9 | Ex. | 0.20 | 1.0 | 2.5 | 1.0 | 0.0017 | 0.0003 | 0.0004 | 0.0008 | 0.0004 | Ni: 0.02 | 2.0 |
| 10 | Ex. | 0.20 | 1.0 | 2.3 | 1.2 | 0.0011 | 0.0004 | 0.0004 | 0.0002 | 0.0007 | Cu: 0.0007 | 2.2 |
| 11 | Ex. | 0.20 | 1.0 | 2.3 | 1.0 | 0.0031 | 0.0007 | 0.0010 | 0.0009 | 0.0007 | Zr: 0.015 | 2.0 |
| 12 | Ex. | 0.20 | 1.0 | 2.2 | 1.0 | 0.0065 | 0.0007 | 0.0006 | 0.0010 | 0.0006 | | 2.0 |
| 13 | Ex | 0.20 | 1.0 | 2.3 | 1.0 | 0.0021 | 0.0006 | 0.0011 | 0.0012 | 0.0008 | | 2.0 |
| 14 | Ex. | 0.20 | 1.0 | 2.3 | 1.0 | 0.0031 | 0.0007 | 0.0010 | 0.0008 | 0.0007 | | 2.0 |
| 15 | Ex. | 0.20 | 1.0 | 2.5 | 1. | 0.0099 | 0.0006 | 0.0003 | 0.0006 | 0.0006 | | 2.0 |
| 16 | Ex | 0.25 | 1.0 | 2.2 | 1.0 | 0.0012 | 0.0006 | 0.0007 | 0.0005 | 0.0007 | Nb: 0.010 | 2.0 |
| 17 | Ex. | 0.25 | 1.0 | 2.2 | 1.0 | 0.0040 | 0.0006 | 0.0003 | 0.0009 | 0.0002 | V: 0.007 | 2.0 |
| 18 | Ex. | 0.30 | 1.0 | 2.5 | 1.0 | 0.0099 | 0.0006 | 0.0002 | 0.0003 | 0.0005 | | 2.0 |
| 19 | Ex. | 0.20 | 1.0 | 2.3 | 1.0 | 0.0031 | 0.0004 | 0.0008 | 0.0003 | 0.0006 | Zr: 0.015 | 2.0 |
| 20 | Ex | 0.20 | 1.0 | 2.3 | 1.0 | 0.0031 | 0.0008 | 0.0002 | 0.0003 | 0.0010 | Zr: 0.015 | 2.0 |
| 21 | Ex. | 0.20 | 1.0 | 2.3 | 1.0 | 0.0031 | 0.0002 | 0.0001 | 0.0003 | 0.0007 | Zr: 0.015 | 2.0 |
| 22 | Ex. | 0.30 | 1.2 | 0.3 | 1.0 | 0.0110 | 0.0002 | 0.0005 | 0.0007 | 0.0001 | | 2.2 |
| 23 | Ex | 0.35 | 1.0 | 5.0 | 1.0 | 0.0092 | 0.0009 | 0.0007 | 0.0007 | 0.0008 | Mo: 0.1 | 2.0 |
| 24 | Ex | 0.35 | 0.9 | 2.2 | 1.3 | 0.0091 | 0.0008 | 0.0007 | 0.0008 | 0.0003 | REM: 0.0006 | 2.2 |
| 25 | Ex. | 0.40 | 1.0 | 2.2 | 1.0 | 0.0045 | 0.0002 | 0.0007 | 0.0001 | 0.0010 | | 2.0 |
| 26 | Ex. | 0.40 | 1.0 | 2.2 | 1.0 | 0.0035 | 0.0003 | 0.0007 | 0.0009 | 0.0009 | W: 0.02 | 2.0 |
| 27 | Ex. | 0.40 | 1.0 | 2.2 | 1.0 | 0.0082 | 0.0003 | 0.0009 | 0.0002 | 0.0002 | Ca: 0.0002 | 2.0 |
| 28 | Ex. | 0.40 | 1.0 | 2.2 | 1.0 | 0.0080 | 0.0002 | 0.0003 | 0.0006 | 0.0010 | | 2.0 |
| 29 | Comp. ex. | 0.42 | 1.0 | 2.0 | 1.0 | 0.0100 | 0.0006 | 0.0007 | 0.0003 | 0.0006 | | 2.0 |
| 30 | Comp. ex. | 0.20 | 0.6 | 2.0 | 1.2 | 0.0100 | 0.0002 | 0.0007 | 0.0009 | 0.0002 | | 1.8 |
| 31 | Comp. ex. | 0.20 | 0.6 | 2.0 | 1.0 | 0.0100 | 0.0002 | 0.0007 | 0.0009 | 0.0002 | | 1.6 |
| 32 | Comp. ex. | 0.20 | 3.1 | 2.0 | 1.0 | 0.0100 | 0.0007 | 0.0004 | 0.0004 | 0.0006 | | 4.1 |
| 33 | Comp. ex. | 0.20 | 1.2 | 2.0 | 0.6 | 0.0100 | 0.0005 | 0.0007 | 0.0005 | 0.0008 | | 1.8 |
| 34 | Comp. ex. | 0.20 | 1.0 | 2.0 | 0.6 | 0.0100 | 0.0005 | 0.0007 | 0.0005 | 0.0008 | | 1.6 |
| 35 | Comp. ex. | 0.20 | 1.0 | 2.0 | 2.2 | 0.0099 | 0.0006 | 0.0007 | 0.0004 | 0.0005 | | 3.2 |
| 36 | Comp. ex. | 0.20 | 0.7 | 2.0 | 0.7 | 0.0100 | 0.0001 | 0.0005 | 0.0008 | 0.0008 | | 1.4 |
| 37 | Comp. ex. | 0.20 | 1.0 | 2.0 | 1.0 | 0.0100 | 0.0002 | 0.0008 | 0.0009 | 0.0004 | | 2.0 |
| 38 | Comp. ex. | 0.20 | 1.0 | 2.0 | 1.0 | 0.0100 | 0.0008 | 0.0004 | 0.0001 | 0.0006 | | 2.0 |
| 39 | Comp. ex. | 0.20 | 1.0 | 2.0 | 1.0 | 0.0100 | 0.0001 | 0.0009 | 0.0007 | 0.0002 | | 2.0 |
| 40 | Comp. ex. | 0.08 | 1.0 | 2.0 | 1.0 | 0.0100 | 0.0009 | 0.0007 | 0.0008 | 0.0004 | | 2.0 |
| 41 | Comp. ex. | 0.20 | 1.0 | 2.0 | 1.0 | 0.0100 | 0.0003 | 0.0001 | 0.0001 | 0.0007 | | 2.0 |
| 42 | Comp. ex. | 0.20 | 1.0 | 2.0 | 1.0 | 0.0100 | 0.0002 | 0.0002 | 0.0007 | 0.0007 | | 2.0 |
| 43 | Comp. ex. | 0.20 | 1.0 | 2.0 | 1.0 | 0.0100 | 0.0008 | 0.0006 | 0.0008 | 0.0002 | | 2.0 |

*Underlines show outside scope of present invention.

TABLE 4

| | | Pretreatment step | | Annealing step | | |
|---|---|---|---|---|---|---|
| | | | Surface roughness | Holding temp. | Holding time | Dew point |
| No. | Class | Condition | after pretreatment | (° C.) | (s) | (° C.) |
| 1 | Ex. | A | A | 800 | 100 | 0 |
| 2 | Ex. | A | A | 800 | 100 | 0 |
| 3 | Ex. | A | A | 800 | 230 | 0 |
| 4 | Ex. | A | AA | 820 | 100 | 0 |
| 5 | Ex. | A | AA | 840 | 100 | 0 |
| 6 | Ex. | A | AA | 860 | 100 | 0 |
| 7 | Ex. | A | AA | 860 | 100 | 0 |
| 8 | Ex. | A | AA | 860 | 100 | 0 |
| 9 | Ex. | A | AA | 860 | 100 | 0 |
| 10 | Ex. | A | AA | 860 | 100 | 0 |
| 11 | Ex. | A | AA | 860 | 20 | 0 |
| 12 | Ex. | A | AA | 860 | 150 | 0 |
| 13 | Ex. | A | AA | 900 | 20 | 0 |
| 14 | Ex. | A | AA | 750 | 50 | 0 |
| 15 | Ex. | A | AA | 780 | 150 | 0 |
| 16 | Ex. | A | AA | 860 | 150 | 0 |
| 17 | Ex. | A | AA | 860 | 40 | 0 |
| 18 | Ex. | A | AA | 860 | 150 | 0 |
| 19 | Ex. | A | AA | 860 | 20 | 0 |
| 20 | Ex. | A | AA | 860 | 20 | 0 |
| 21 | Ex. | A | AA | 860 | 20 | 0 |
| 22 | Ex. | A | AA | 860 | 300 | 0 |
| 23 | Ex. | A | AA | 860 | 200 | 0 |
| 24 | Ex. | A | A | 860 | 200 | 0 |
| 25 | Ex. | A | AA | 860 | 200 | 0 |
| 26 | Ex. | A | AA | 860 | 200 | −20 |
| 27 | Ex. | A | AA | 860 | 200 | 0 |
| 28 | Ex. | A | AA | 860 | 200 | 0 |
| 29 | Comp. ex. | A | A | 800 | 60 | 0 |
| 30 | Comp. ex. | A | A | 800 | 60 | 0 |
| 31 | Comp. ex. | A | A | 800 | 60 | 0 |
| 32 | Comp. ex. | A | A | 800 | 70 | 0 |
| 33 | Comp. ex. | A | A | 800 | 60 | 0 |
| 34 | Comp. ex. | A | A | 800 | 60 | 0 |
| 35 | Comp. ex. | A | A | 800 | 60 | 0 |
| 36 | Comp. ex. | A | A | 800 | 60 | 0 |
| 37 | Comp. ex. | A | A | 800 | 60 | −40 |
| 38 | Comp. ex. | A | A | 800 | 60 | 30 |
| 39 | Comp. ex. | A | A | 720 | 60 | 0 |
| 40 | Comp. ex. | A | A | 920 | 60 | 0 |
| 41 | Comp. ex. | A | A | 800 | 10 | 0 |
| 42 | Comp. ex. | None | A | 800 | 60 | 0 |
| 43 | Comp. ex. | B | B | 800 | 60 | 0 |

* Underlines show outside scope of preferable method of production.

### (Evaluation of Surface Layer Structure)

A sample cut to 30 mm×30 mm was taken from the obtained plated steel sheet and measured under the above conditions five times in the sheet thickness direction by GDS. The depth with a C concentration of 0.05% or less was found. This was shown as the “C≤0.05% depth” of Table 5. Here, the starting point of “depth” is the interface of the plating layer and base steel sheet.

Further, a sample cut to 25 mm×15 mm was taken and etched by Nital. The above-mentioned method was used to measure the thickness of the layer with a ferrite phase of 90% or more. This was shown as the “α phase thickness” in Table 5. Here, the starting point of “thickness” is the interface of the plating layer and base steel sheet.

Further, the plating was removed using a 10 mass % hydrochloric acid solution to which 0.06 mass % of an inhibitor (Ibit made by Asahi Chemical Co., Ltd.) was added. The roughness of the surface of the steel sheet exposed was measured by a method similar to before annealing. The result was shown in “base steel sheet/plating interface roughness” of Table 5.

### (Evaluation of Tensile Strength)

For each steel sheet, a JIS No. 5 tensile test piece having a direction at right angles to the rolling direction as its longitudinal direction was taken, a tensile test was conducted based on JIS Z 2241:2011, the tensile strength was found, and the sheet was evaluated as follows:
Evaluation AAA: 1180 MPa or more
Evaluation AA: 980 MPa or more and less than 1180 MPa
Evaluation A: 780 MPa or more and less than 980 MPa

### (Evaluation of LME Resistance)

From each steel sheet, two samples cut to 50 mm×100 mm size were taken. These two samples were spot welded using weld electrodes of a dome radius type having tip diameters of 8 mm under conditions of an electrode angle of 2°, a squeezing force of 4.0 kN, an energizing time of 0.5 second, and an energizing current of 12 kA so as to produce a welded joint.

Referring to FIG. 2, evaluation of the LME resistance will be explained. The LME resistance was obtained by overlaying and spot welding two steel sheets 1 and evaluating them by the length of an LME crack (crack 11 of shoulder part) occurring at a shoulder part of the welded part 2 formed. A “shoulder part” means a slanted part of a crevice of a recess formed due to the spot welding. The length of cracks of the shoulder part was used for evaluation as follows. In the present embodiment, if the evaluation A or more, it was judged that the LME resistance was excellent and that the technical problem of the present invention was solved.
Evaluation AAA: 0μ m
Evaluation AA: more than 0 μm and less than 60 μm
Evaluation A: 60 μm or more and less than 120 μm

Evaluation B: 120 μm or more

### (Evaluation of Red Rust Resistance)

From each steel sheet, a sample cut to 75 mm×100 mm size was taken. The end face and back side of the sample were protected by tape sealing. After that, cross cuts were formed reaching the plating layer and a salt spray test using 5% NaCl held at 35° C. was performed based on JIS Z 2371:2015. The test was performed for up to 2000 hours and the time period until red rust formation after the test was found. The samples were evaluated as follows in accordance with the time periods until red rust formation. In the examples, an evaluation of A or more was evaluated as excellent in red rust resistance.
Evaluation AAA: time period until red rust formation 2000 hours or more
Evaluation AA: time period until red rust formation 1000 hours or more and less than 2000 hours
Evaluation A: time period until red rust formation 240 hours or more and less than 1000 hours
Evaluation B: time period until red rust formation less than 240 hours

The results of the evaluations are shown in Table 5.

TABLE 5

| | | | | Base steel | | | | |
|---|---|---|---|---|---|---|---|---|
| | | Steel surface layer structure | | sheet/plating | | Performance | | |
| | | | α phase | interface | | Tensile | | |
| | | C ≤ 0.05% | thickness | roughness | Plating | strength | | |
| No. | Class | depth (μm) | (μm) | (μm) | type | (MPa) | LME resistance | Red rust resistance |
| 1 | Ex. | 21 | 25 | 3.0 | A | A | AA | A |
| 2 | Ex. | 23 | 21 | 2.3 | A | AA | AA | A |
| 3 | Ex. | 30 | 62 | 2.4 | A | A | AA | A |
| 4 | Ex. | 21 | 30 | 1.9 | A | AA | AAA | A |
| 5 | Ex. | 20 | 22 | 1.7 | A | AA | A | A |
| 6 | Ex. | 25 | 30 | 1.5 | A | AA | AAA | A |
| 7 | Ex. | 21 | 40 | 1.6 | A | AA | AAA | A |
| 8 | Ex. | 22 | 28 | 1.4 | A | AA | AA | A |
| 9 | Ex. | 21 | 42 | 1.1 | A | AA | AAA | A |
| 10 | Ex. | 20 | 44 | 1.7 | A | AA | AAA | A |
| 11 | Ex. | 10 | 20 | 1.3 | A | AA | A | A |
| 12 | Ex. | 25 | 45 | 1.1 | C | AA | AA | A |
| 13 | Ex. | 12 | 21 | 1.3 | A | AA | A | A |
| 14 | Ex. | 10 | 20 | 1.2 | A | AA | A | A |
| 15 | Ex. | 25 | 33 | 1.8 | A | AAA | AAA | A |
| 16 | Ex. | 22 | 39 | 1.6 | A | AAA | AAA | A |
| 17 | Ex. | 18 | 27 | 1.4 | A | AAA | A | A |
| 18 | Ex. | 29 | 42 | 1.7 | A | AAA | AAA | A |
| 19 | Ex. | 10 | 22 | 1.3 | B | AA | A | AA |
| 20 | Ex. | 10 | 20 | 1.3 | D | AA | AAA | AAA |
| 21 | Ex. | 10 | 21 | 1.3 | E | AA | AAA | AAA |
| 22 | Ex. | 40 | 80 | 1.8 | A | AA | AAA | A |
| 23 | Ex. | 28 | 38 | 1.3 | A | AAA | AAA | A |
| 24 | Ex. | 28 | 34 | 2.2 | A | AAA | AAA | A |
| 25 | Ex. | 27 | 33 | 1.0 | A | AAA | AAA | A |
| 26 | Ex. | 25 | 31 | 1.9 | A | AAA | AAA | A |
| 27 | Ex. | 22 | 33 | 1.2 | A | AAA | AAA | A |
| 28 | Ex. | 21 | 30 | 1.6 | A | AAA | AAA | A |
| 29 | Comp. ex. | 1 | 17 | 2.6 | A | AAA | B | B |
| 30 | Comp. ex. | 4 | 8 | 2.6 | A | AAA | B | B |
| 31 | Comp. ex. | 2 | 7 | 2.6 | A | AAA | B | B |
| 32 | Comp. ex. | 6 | 21 | 2.2 | A | AAA | B | B |
| 33 | Comp. ex. | 4 | 7 | 2.5 | A | AAA | B | B |
| 34 | Comp. ex. | 1 | 6 | 2.6 | A | AAA | B | B |
| 35 | Comp. ex. | 5 | 20 | 2.3 | A | AAA | B | B |
| 36 | Comp. ex. | 5 | 7 | 2.6 | A | AAA | B | B |
| 37 | Comp. ex. | Not evaluable due to nonplating defect | | | | | | |
| 38 | Comp. ex. | | | | | | | |
| 39 | Comp. ex. | 2 | 2 | 2.4 | A | AAA | B | B |
| 40 | Comp. ex. | 7 | 5 | 2.4 | A | AAA | B | B |
| 41 | Comp. ex. | 3 | 4 | 2.5 | A | AAA | B | B |
| 42 | Comp. ex. | 8 | 12 | 2.7 | A | AAA | B | B |
| 43 | Comp. ex. | 11 | 11 | 3.1 | A | AAA | B | B |

※Underlines show outside scope of present invention or desired properties not obtained

No. 29 is a comparative example with a large content of C in the steel sheet. Since the content of C in the steel sheet was large, it is believed that decarburization did not proceed at the surface layer even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 30 is a comparative example with a low content of Si in the steel sheet. Since the content of Si in the steel sheet was small, it is believed that decarburization did not proceed at the surface layer and the ferrite did not stabilize even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 31 is a comparative example with a small content of Si and sum of contents of Si and sol. Al of the steel sheet. Since the content of Si and the sum of contents of Si and sol. Al of the steel sheet were small, it is believed that decarburization did not proceed at the surface layer and the ferrite did not stabilize even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 32 is a comparative example with a large content of Si of the steel sheet. Since the content of Si was large, it is believed that external oxidation proceeded, oxides (scale) formed at the surface layer of the steel sheet, and decarburization at the surface was suppressed even if performing high dew point annealing. For this reason, the depth with a C concentration of 0.05% or less did not become large. As a result, the LME resistance became inferior. Further, the red rust resistance also deteriorated.

No. 33 is a comparative example with a small content of sol. Al of the steel sheet. Since the content of sol. Al of the steel sheet was small, it is believed that decarburization at the surface layer did not proceed and the ferrite did not stabilize even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 34 is a comparative example with a small content of sol. Al and sum of contents of Si and sol. Al of the steel sheet. Since the content of sol. Al and sum of contents of Si and sol. Al of the steel sheet was small, it is believed that decarburization did not proceed at the surface layer and the ferrite did not stabilize even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 35 is a comparative example with a large content of sol. Al of the steel sheet. Since the content of sol. Al of the steel sheet was large, it is believed that even if performing high dew point annealing, external oxidation proceeded, oxides (scale) were formed at the surface layer of the steel sheet, and decarburization at the surface was suppressed. For this reason, the depth with a C concentration of 0.05% or less did not become large. As a result, the LME resistance became inferior. Further, the red rust resistance also deteriorated.

No. 36 is a comparative example with a small sum of contents of Si and sol. Al of the steel sheet. Since the sum of contents of Si and sol. Al of the steel sheet was small, it is believed that that decarburization did not proceed at the surface layer and the ferrite did not stabilize even if performing high dew point annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 37 was low in dew point at the time of annealing, so at the time of annealing, phases containing Si, Mn, Al, and other oxides were formed at the outside of the steel sheet and, at the time of plating treatment, it is believed that mutual diffusion of the plating constituents and steel constituents was obstructed. As a result, suitable plating could not be obtained.

No. 38 was high in dew point at the time of annealing, so at the time of annealing, phases containing Si, Mn, Al, and other oxides were formed at the outside of the steel sheet and, at the time of plating treatment, mutual diffusion of the plating constituents and steel constituents was obstructed. As a result, suitable plating could not be obtained.

No. 39 was low in holding temperature at the time of annealing, so it is believed the decarburization did not sufficiently proceed at the time of annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 40 was high in holding temperature at the time of annealing, so it is believed decarburization was not sufficiently promoted at the time of annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 41 was short in holding time at the time of annealing, so it is believed decarburization was not sufficiently promoted at the time of annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 42 was not brushed in the pretreatment process, so it is believed that strain was not introduced into the surface of the steel sheet and decarburization did not proceed at the time of annealing. For this reason, the depth with a C concentration of 0.05% or less and the thickness of the layer with an area ratio of a ferrite phase of 90% or more did not become large. As a result, the LME resistance became inferior. Further, the red rust resistance also deteriorated.

No. 43 used a brush roll with large amount of grinding in brushing in the pretreatment step, so it is believed that the roughness of the steel sheet surface became greater and, further, the ferrite phase did not become stable. For this reason, the thickness of the layer with an area ratio of a ferrite phase of 90% or more did not become large. As a result, the LME resistance became inferior. Further, the red rust resistance also deteriorated.

On the other hand, Nos. 1 to 28 were examples of the present invention and had high LME resistance. Further, they were excellent in red rust resistance. It was confirmed that in examples with a large depth with a C concentration of 0.05% or less and thickness of the layer with an area ratio of a ferrite phase of 90% or more, there was particularly excellent LME resistance.

### INDUSTRIAL APPLICABILITY

According to the present invention, it becomes possible to provide plated steel sheet having high LME resistance. That plated steel sheet can be suitably used for automobiles, household electric appliances, building materials, and other applications, in particular for automobiles. Therefore, the present invention is an invention extremely high in industrial applicability.

### REFERENCE SIGNS LIST

1 steel sheet
2 welded part
11 crack of shoulder part

1. A plated steel sheet with a tensile strength of 780 MPa or more comprising a plating layer containing Zn on one surface or two surfaces of a base steel sheet,
the chemical composition of the base steel sheet comprising, by mass %,
C: 0.05 to 0.40%,
Si: 0.7 to 3.0%,
Mn: 0.1 to 5.0%,
sol. Al: 0.7 to 2.0%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%,
REM: 0 to 0.100% and
a balance of Fe and impurities,
a total value of the contents of Si and sol. Al is 1.8% or more,
a depth with a C concentration, measured by GDS, of 0.05% or less in a depth direction of the plated steel sheet starting from an interface of the base steel sheet and the plating layer is 10 μm or more,
a thickness of a layer with an area ratio of a ferrite phase of 90% or more in a depth direction of the plated steel sheet starting from an interface of the base steel sheet and the plating layer is 20 μm or more, and
a surface roughness of the interface of the base steel sheet and the plating layer is an Ra of 3.0 μm or less,
the plating layer containing, by mass %, less than 3.0% of Fe and a balance of Zn and impurities.

2. The plated steel sheet according to claim 1, wherein the roughness of the interface of the base steel sheet and the plating layer is an Ra of 2.0 μm or less.

3. The plated steel sheet according to claim 1, wherein the depth with a C concentration, measured by GDS, of 0.05% or less in a depth direction of the plated steel sheet starting from an interface of the base steel sheet and the plating layer is 20 μm or more,

4. The plated steel sheet according to claim 1, wherein the thickness of a layer with an area ratio of a ferrite phase of 90% or more in a depth direction of the plated steel sheet starting from an interface of the base steel sheet and the plating layer is 30 μm or more.

5. The plated steel sheet according to claim 1, wherein the plating layer comprises, instead of part of the Zn, by mass %, Al: 0 to 30.0% and Mg: 0 to 10.0%.

6. The plated steel sheet according to claim 1, wherein the plating layer comprises, instead of part of the Zn, by mass %, Al: 10 to 30.0% and Mg: 4.5 to 10.0%.

7. The plated steel sheet according to claim 2, wherein the plating layer comprises, instead of part of the Zn, by mass %, Al: 0 to 30.0% and Mg: 0 to 10.0%.

8. The plated steel sheet according to claim 3, wherein the plating layer comprises, instead of part of the Zn, by mass %, Al: 0 to 30.0% and Mg: 0 to 10.0%.

9. The plated steel sheet according to claim 4, wherein the plating layer comprises, instead of part of the Zn, by mass %, Al: 0 to 30.0% and Mg: 0 to 10.0%.

10. The plated steel sheet according to claim 2, wherein the plating layer comprises, instead of part of the Zn, by mass %, Al: 10 to 30.0% and Mg: 4.5 to 10.0%.

11. The plated steel sheet according to claim 3, wherein the plating layer comprises, instead of part of the Zn, by mass %, Al: 10 to 30.0% and Mg: 4.5 to 10.0%.

12. The plated steel sheet according to claim 4, wherein the plating layer comprises, instead of part of the Zn, by mass %, Al: 10 to 30.0% and Mg: 4.5 to 10.0%.
